(19) United States
(12) Patent Application Publication
(10) Pub. No.: US 2026/0300806 A1
(43) Pub. Date: Oct. 1, 2026

(54) FAST QUANTIZATION FOR NEURAL NETWORKS

(71) Applicants: XILINX, INC., San Jose, CA (US); Xilinx Technology Bejing Limited, Beijing (CN); Xilinx India Technology Services Pvt. Ltd., Hyderabad (IN)

(72) Inventors: Nithin Kumar Guggilla, Hyderabad (IN); Chao Li, Beijing (CN); Satyaprakash Pareek, San Jose, CA (US)

(21) Appl. No.: 19/091,815

(22) Filed: Mar. 26, 2025

(51) Int. Cl. G06N 20/00; G06F 18/24

(52) U.S. Cl. CPC G06N 20/00; G06F 18/24

(57) ABSTRACT

A processing unit compares a first graph that represents a machine learning (ML) model and a second graph that represents a previously quantized ML model generated by quantizing a previous version of the ML model. Based on the comparison, a processing unit selectively reuses a first subset of quantization parameters from the previously quantized ML model and re-quantizes a second portion of the version of the ML model to form a second subset of the quantization parameters. The first subset is formed by quantizing a first portion of the previous version of the ML model. The processing unit combines the first subset and the second subset to form an updated quantized ML model. In some cases, the version of the ML model has a floating-point representation, and the previously quantized ML model is generated by quantizing a previous version of the ML model to form a fixed point representation.

### BACKGROUND

Machine learning (ML) models, which include artificial intelligence (AI) models and techniques, operate on numerical representations of data such as text, audio, and images. A typical numerical representation is an embedding such as a vector embedding that encodes features of the data in a series (or vector) of numerical values. An ML model is trained to transform the numerical representation of the input data into one or more output values such as a value indicating the identity of a feature in the data, a classification of the feature, or a value that is predicted based upon the input data. Neural networks are often used to implement ML models. A typical neural network includes an input layer, one or more hidden layers, and an output layer formed of interconnected sets of nodes. The nodes are connected so that the output of nodes in one layer becomes the input to nodes in a subsequent layer. As data is passed from one node to the next, the data is multiplied by a weight associated with the connection between the two nodes. The weight therefore represents the strength of the connection between the two nodes. Nodes combine the weighted inputs, typically as a linear combination, to determine a value that is provided to an activation function that determines whether the node should “activate.” Examples of activation functions include a sigmoid function, a rectified linear unit (ReLU) function, a softmax function, and a hyperbolic tangent function. Training the ML model includes, for example, determining values of the weights and activation functions based on training data.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that updates quantized machine learning (ML) models by combining portions of previously quantized versions of an ML model with re-quantized portions of the ML model, according to some embodiments.

FIG. 2 illustrates an ML model that uses a floating-point representation and a quantized ML model that uses a fixed point representation formed by quantizing the ML model, according to some embodiments.

FIG. 3 illustrates an updated version of an ML model that uses a floating-point representation and a quantized ML model that uses a fixed-point representation formed by quantizing the ML model, according to some embodiments.

FIG. 4 illustrates layers of an ML model that are selectively re-quantized using a quantization algorithm to convert a floating-point representation of weights and activation functions in the layers to a fixed-point representation, according to some embodiments.

FIG. 5 illustrates the first portion of a method for selectively reusing previously determined quantization parameters for an ML model and re-quantizing remaining quantization parameters for the ML model, according to some embodiments.

FIG. 6 illustrates the second portion of the method for selectively reusing previously determined quantization parameters for an ML model and re-quantizing remaining quantization parameters for the ML model, according to some embodiments.

### DETAILED DESCRIPTION

The weights and activation functions that represent an ML model are typically represented as floating point numbers in a format such as FP32 or FP16. However, the memory requirements and computational complexity of the neural network can become intractably large as the size of the neural network increases. Quantization therefore can be used to reduce the precision of the weights and activation functions from the floating-point values to a smaller representation such as fixed point, integer formats INT8 or INT4. Quantization can be performed by introducing a quantization algorithm into the training process for the ML model (e.g., quantization aware training, QAT) or applying quantization to a previously trained ML model (e.g., post training quantization PTQ, which can also include fine-tuning). Both elements of the model quantization process—the ML model and the quantizer software—change relatively frequently. The ML model can change to optimize or increase the floating-point accuracy; the quantizer software can change to support new enhancements, optimizations, or bug fixes. A conventional ML model can be re-quantized in response to a change in either the ML model or the quantizer software. In many cases, the re-quantization process incurs significant overhead that can impact the time to market for the application.

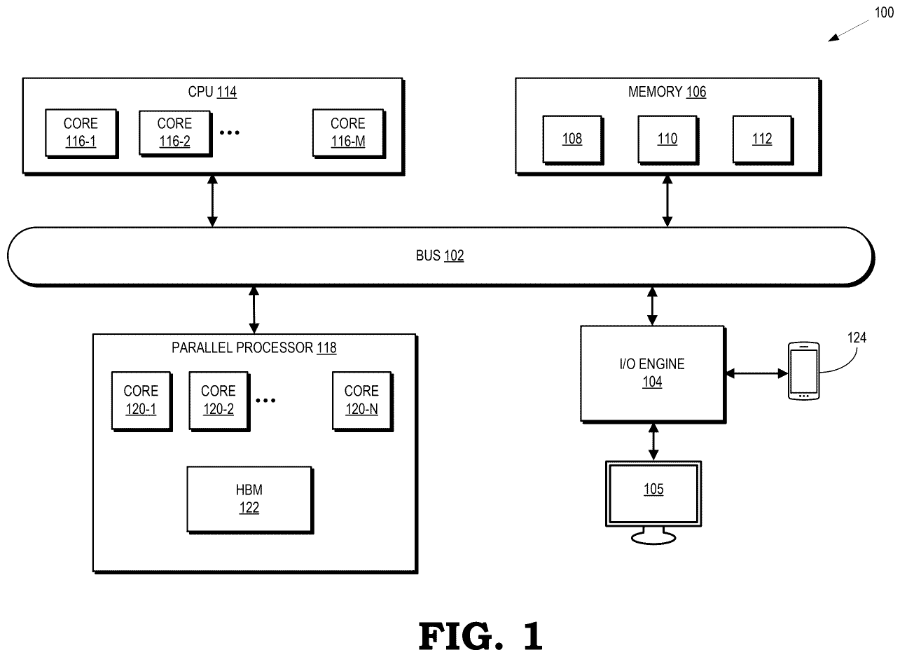

FIGS. 1-6 illustrate systems, apparatuses, and methods of reducing the overhead for re-quantizing an ML model by selectively reusing quantization parameters for a first portion (or subgraph) of a previously quantized ML model and re-quantizing a separate second portion (or subgraph) of the ML model. The previously quantized ML model is generated by quantizing a previous version of the ML model using a previous version of the quantization algorithm. As discussed herein, re-quantization can be performed in response to a change in the previous version of the ML model, a change in the previous version of the quantization algorithm, or both. Changes in the ML models are detected by identifying mismatches between corresponding layers in the previous version of the ML model and the (current) ML model. As used herein, two layers “match” when the two layers implement the same functionality and produce the same output in response to the same input. For example, a layer in a previous version of the ML model that implements 4×4 convolution matches a layer in the current ML model that also implements 4×4 convolution. There is a “mismatch” between two layers if they implement different functionality that produces different output in response to the same input. For example, there is a mismatch between a layer in a previous version of the ML model that implements 4×4 convolution and a layer in the current ML model that implements pooling. For another example, there is a mismatch between a layer in the previous version of the ML model that implements 4×4 convolution and a layer in the current ML model that implements 1×1 convolution.

In some embodiments, a processing unit (such as a parallel processor or graphics processing unit, GPU) detects a change in the ML model based on a comparison of topologies of a current ML model and a previously quantized ML model. For example, the processing unit can compare a first topology of a first graph representing the current ML model to a second topology of a second graph representing the previously quantized ML model. The comparison proceeds layer-by-layer beginning at a first layer (such as the input layer), and the processing unit bypasses the quantization/dequantization layers in the previously quantized ML model. If the processing unit detects a mismatch between corresponding layers of the first topology and the second topology, the processing unit determines a percentage of layers of the first graph and the second graph that matched. If the percentage is less than a threshold (such as 40%), then the entire ML model is re-quantized. Otherwise, if the percentage is greater than the threshold, the first graph (of the previously quantized ML model) is partitioned into a first subgraph that includes the matching portion and a second subgraph that includes the remaining, mismatched portion. The processing unit generates a second (re-quantized) subgraph by re-quantizing the mismatched portion based on the corresponding portion of the ML model and calibration data associated with a corresponding portion. The first subgraph and the second sub graph are then combined to form an updated quantized ML model. In some cases, the re-quantization is performed in response to changes in characteristics of the quantization technique, which can be indicated in metadata associated with the quantization technique.

FIG. 1 is a block diagram of a processing system 100 that updates quantized ML models by combining portions of previously quantized versions of an ML model with re-quantized portions of the ML model, according to some embodiments. The processing system 100 includes a bus 102 implemented with circuitry that supports communication between entities implemented in the processing system 100. Some implementations of the processing system 100 include other buses, bridges, switches, routers, and the like, which are not shown in FIG. 1 in the interest of clarity. An input/output (I/O) engine 104 is implemented with circuitry that handles input or output operations associated with display 105, as well as other elements of the processing system 100 such as keyboards, mice, printers, external disks, and the like. The I/O engine 104 is coupled to the bus 102 so that the I/O engine 104 can communicate with other entities in the processing system 100 by exchanging signals over the bus 102.

Processing system 100 also includes or has access to a memory 106 or other storage component implemented using a non-transitory computer-readable medium such as a dynamic random-access memory (DRAM). However, some embodiments of the memory 106 are implemented using other types of memory including, for example, static random-access memory (SRAM), nonvolatile RAM, and the like. Some embodiments of the memory 106 include an external memory implemented external to the processing units implemented in the processing system 100. The memory 106 can store information representing instructions such as program code 108 for one or more applications (e.g., graphics applications, compute applications, ML models or applications), data 110 that is consumed by the program code 108, and results 112 produced by executing the program code 108.

The processing system 100 includes a central processing unit (CPU) 114 that is connected to the bus 102 to communicate with other entities in the processing system 100, such as the I/O engine 104, the memory 106, or other entities connected to the bus 102. The CPU 114 is implemented with circuitry including one or more processor cores 116, such as the illustrated plurality of processor cores 116-1, 116-2, . . . 116-M that execute instructions concurrently or in parallel. Although three processor cores 116 are shown in FIG. 1, more or fewer processor cores 116 can be implemented in other embodiments of the CPU 114. The processor cores 116 include circuitry to implement one or more compute units such as single-instruction, multiple data (SIMD) units that perform the same operation on different data sets to produce one or more results. The CPU 114 is configured to execute instructions such as the program code 108 for one or more applications (e.g., graphics applications, compute applications, machine learning applications), which is stored in the memory 106. The CPU 114 can consume data 110 and store information in the memory 106 such as the results 112 of the executed instructions.

The processing system 100 also includes a parallel processor 118. The parallel processor 118 can include, for example, a GPU, a general-purpose GPU (GPGPU), a neural processing unit (NPU), an intelligence processing unit (IPU) or other vector processor or type of parallel processor. The parallel processor 118 includes circuitry to implement one or more processor cores 120-1 . . . N that each operate as a compute unit configured to perform one or more operations based on one or more instructions received by the parallel processor 118. Although three processor cores 120 are shown in FIG. 1, more or fewer processor cores 120 can be implemented in other embodiments of the parallel processor 118. The compute units in the processor cores 120 are implemented as circuitry for one or more single-instruction, multiple data (SIMD) units that perform the same operation on different data sets to produce one or more results.

In the illustrated embodiment, the parallel processor 118 includes circuitry for storing data such as one or more high bandwidth memories (HBM) 122 that are used to store instructions or data that are accessed by one or more of the processor cores 120 via high bandwidth connections (not shown in FIG. 1 in the interest of clarity). Some embodiments of the HBM 122 store instructions or information that has been retrieved or fetched from memory 106. For example, instructions can be fetched from the program code 108 and stored in HBM 122 and data can be fetched from the data 110 and stored in the HBM 122. Although the HBM 122 is shown internal to the parallel processor 118 and external to the processor cores 120, some embodiments of the processor cores 120 include additional, internal HBM or caches and some embodiments of the HBM 122 are implemented external to the parallel processor 118.

The parallel processor 118 is configured to implement selective updating of an ML model by re-quantizing portions of the ML model based on a comparison of a graph of the ML model with the graph of a quantized representation of a previous version of the ML model. One or more of the processor cores 120 of the parallel processor 118 are configured to compare a first graph that represents a machine learning (ML) model and a second graph that represents a previously quantized ML model generated by quantizing a previous version of the ML model. In some embodiments, information representing the ML model, the previously quantized ML model, calibration data, and metadata indicating characteristics of the quantization technique used to generate the previously quantized ML model are stored in a memory such as the memory 106. Portions of the stored information can be fetched from the memory 106 into the HBM 122. Based on the comparison, the parallel processor 118 can selectively reuse a first subset of quantization parameters from the previously quantized ML model and re-quantize a second portion of the ML model to form a second subset of the quantization parameters. The first subset was previously formed by quantizing a first portion of the previous version of the ML model. The parallel processor 118 can then combine the first subset and the second subset to form an updated quantized ML model. In some embodiments, the parallel processor 118 provides information representing the updated second ML model to a device 124 that is configured to perform inference using the updated second ML model based on input values such as a feature map. For example, the device 124 can be configured to generate a value indicating on or more of an identity of a feature in the feature map, a classification of a feature in the feature map, or a value that is predicted based upon the feature map. The device 124 can be a smart phone, an Internet of Things (IoT) device, a neural processing unit (NPU), or other low power device.

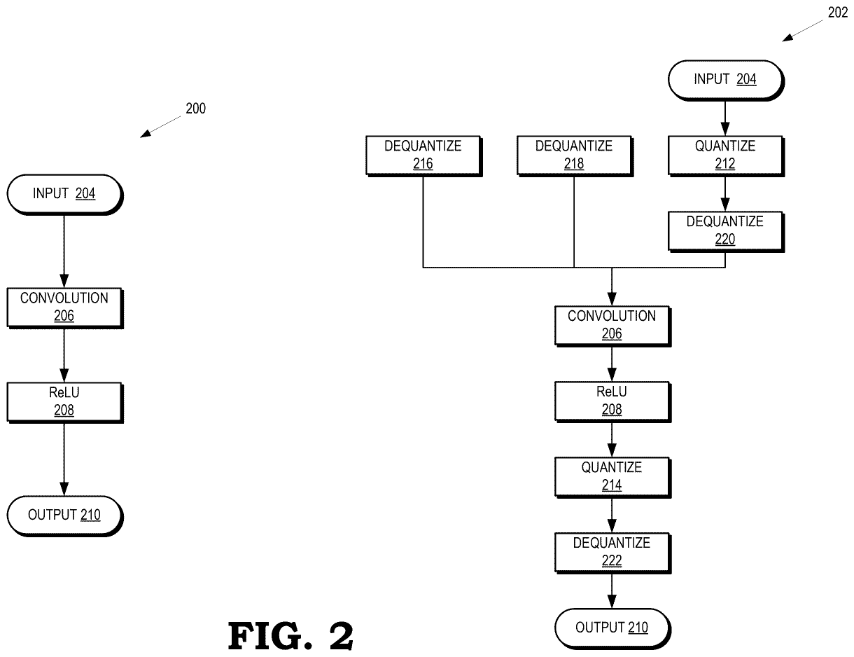

FIG. 2 illustrates an ML model 200 that uses a floating-point representation and a quantized ML model 202 that uses a fixed point representation formed by quantizing the ML model 200, according to some embodiments. The floating-point representation of the model 200 can use representations having different precisions such as an FP32 representation that uses 32 bits or an FP16 representation that uses 16 bits to represent the floating-point numbers such as the weights or activation functions of nodes in the ML model 200. The fixed-point representation of the quantized ML model 202 can also have different precisions such as INT8 that uses eight bits or INT4 that uses four bits to represent the fixed point integers that indicate quantized values of the weights or activation functions of nodes in the ML model 200.

In the illustrated embodiment, the ML model 200 includes an input layer 204 made up of one or more nodes that receive input values of features provided to the ML model 200 for training or inference. The ML model 200 also includes a convolution layer 206 that convolves the input values with a filter associated with the convolution layer 206. A ReLU layer 208 represents an activation function that is applied to values output from the convolution layer 206. The activation function represented by the ReLU layer 208 is a piecewise linear function that outputs the input directly if it is positive; otherwise, it outputs zero. Values generated by the ReLU layer 208 are then provided to an output layer 210. In some embodiments, the input layer 204 receives data such as a tensor representing a feature map and the ML model 200 uses this information to classify one or more features in the received feature map. For example, the ML model 200 can perform computer vision tasks such as image classification, object detection, object tracking, and content-based image retrieval.

The quantized ML model 202 is formed by applying a quantization technique or algorithm to the ML model 200. The quantized ML model 202 has the same topology as the ML model 200 except for additional nodes or layers associated with the quantization or de-quantization technique. In the illustrated embodiment, the quantized ML model 202 includes quantize layers 212, 214 and dequantize layers 216, 218, 220, 222. The (first) topology of the ML model 200 is therefore the same as a (second) topology of the quantized ML model 202 as long as the additional quantize layers 212, 214 and dequantize layers 216, 218, 220, 222 are bypassed or ignored. A comparison of the topologies of the ML model 200 and the quantized ML model 202 are therefore performed after removing, bypassing, or ignoring the quantize layers 212, 214 and dequantize layers 216, 218, 220, 222.

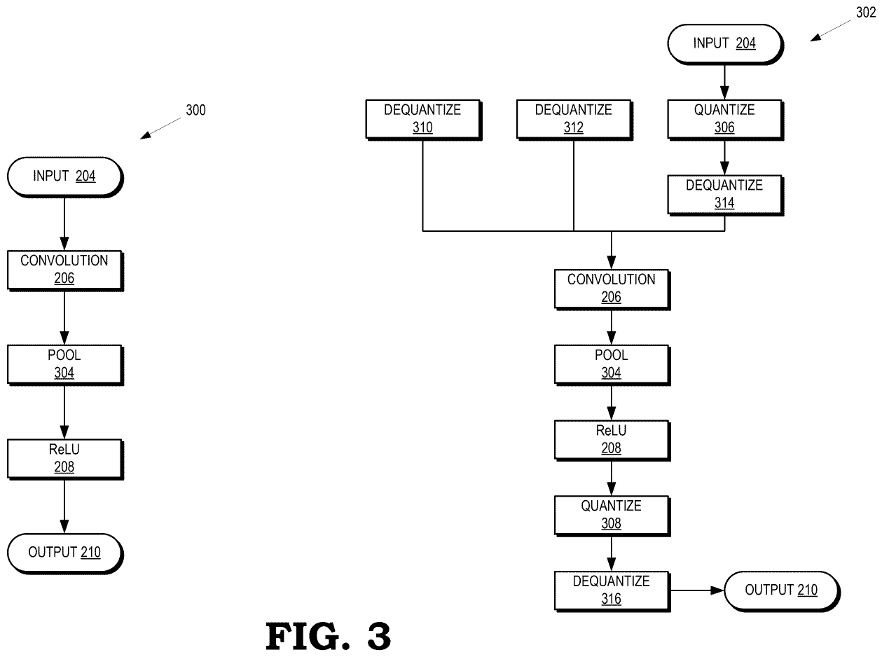

FIG. 3 illustrates an updated version of an ML model 300 that uses a floating-point representation and a quantized ML model 302 that uses a fixed-point representation formed by quantizing the ML model 300, according to some embodiments. The ML model 300 represents a newer version of the ML model 200 shown in FIG. 2 and the quantized ML model 302 represents a newer quantized version of the ML model 200 shown in FIG. 2. The ML model 300 can therefore be referred to as new, later, updated, modified, changed, or other terms to indicate that the ML model 300 is different than the ML model 200, which can be referred to as a previous, earlier, older, or prior version of the ML model 300. The ML model 300 and the one post ML model 302 include the input layer 204, the convolution layer 206, the ReLU layer 208, and the output 210. However, the ML model 300 and the quantized ML model 302 also include a pooling layer 304 that is configured to downsample, aggregate, or otherwise combine information that is dispersed among many vectors into fewer vectors or scalars.

In a conventional system, the quantized ML model 302 is formed by applying a quantization technique or algorithm to the ML model 300. As discussed herein, the quantization technique can be the same or different than the quantization technique used to generate the quantized ML model 202 based on the ML model 200 shown in FIG. 2. The quantized ML model 302 has the same topology as the ML model 300 except for additional nodes or layers associated with the quantization or de-quantization technique. In the illustrated embodiment, the quantized ML model 302 includes quantize layers 306, 308 and dequantize layers 310, 312, 314, 316. The topology of the ML model 300 is therefore the same as the topology of the quantized ML model 302 as long as the additional quantize layers 306, 308 and dequantize layers 310, 312, 314, 316 are bypassed or ignored.

However, as discussed herein, generating the quantized ML model 302 by re-quantizing the entire ML model 300 can be prohibitively resource intensive. Systems such as the processing system 100 shown in FIG. 1 are therefore configured to compare a previously quantized ML model (e.g., the quantized ML model 202) to the current or updated ML model 302 prior to applying the quantization technique. Based on the comparison, the processing system can selectively reuse portions of the previously quantized ML model 202 and re-quantize complementary portions of the updated ML model 300. In the illustrated embodiment, the processing system performs the comparison by removing, ignoring, or bypassing the quantize layers 212, 214 and dequantize layers 216, 218, 220, 222 in the quantized ML model 202 and then comparing the topologies of the quantized ML model 202 and the updated ML model 300. The two topologies differ because of the additional pooling layer 304 in the updated ML model 300. Thus, quantize layers 212 and dequantize layers 216, 218, 220 can be reused so that they are equal to the corresponding quantize layers 306 and dequantize layers 310, 312, 314. Re-quantization is performed from the pooling layer 304 downstream so that the quantize layer 308 and the dequantize layer 316 are different than the quantize layer 214 and the dequantize layer 222 in FIG. 2.

Some embodiments of the quantized ML model 302 are trained to perform tasks in response to receiving input data such as a feature map. For example, a feature map can be provided to the quantized ML model 302. Based on the quantized ML model 302, a value indicating an identity of a feature in the feature map, a classification of a feature in the feature map, a value that is predicted based upon the feature map, or other characteristic or result and be generated by the quantized ML model 302.

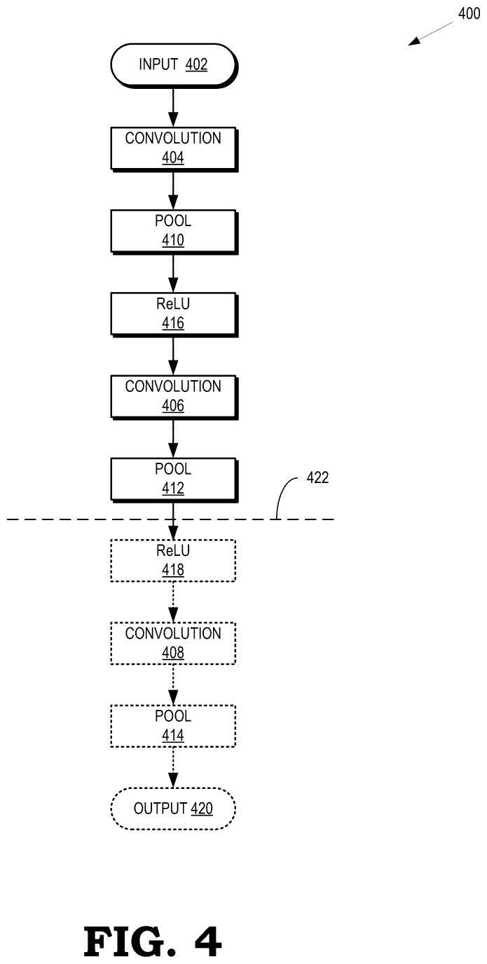

FIG. 4 illustrates layers of an ML model 400 that are selectively re-quantized using a quantization algorithm to convert a floating-point representation of weights and activation functions in the layers to a fixed-point representation, according to some embodiments. The ML model 400 includes an input layer 402, convolution layers 404, 406, 408, pooling layers 410, 412, 414, ReLU layers 416, 418, and output layer 420. The topology of the ML model 400 is compared to a topology of a quantized version of a previous version of the ML model (not shown in FIG. 4 in the interest of clarity) to determine whether the topology of the ML model has changed. In some embodiments, the topologies are compared by comparing a first graph that represents the ML model 400 and a second graph that represents the previously quantized version. The comparison is performed layer-by-layer beginning at a first layer such as the input layer 402. In the illustrated embodiment, a mismatch between the first graph and the second graph is detected after the pooling layer 412, as indicated by the dashed line 422. Thus, quantization parameters that represent the input layer 402, the convolution layers 404, 406, the pooling layers 410, 412, and the ReLU layer 416 can be reused in the quantized version of the ML model 400. Weights and activation functions in the convolution layer 408, the pooling layer 414, and the ReLU layer 418 are re-quantized and then combined with the reused parameters to form the quantized version of the ML model 400.

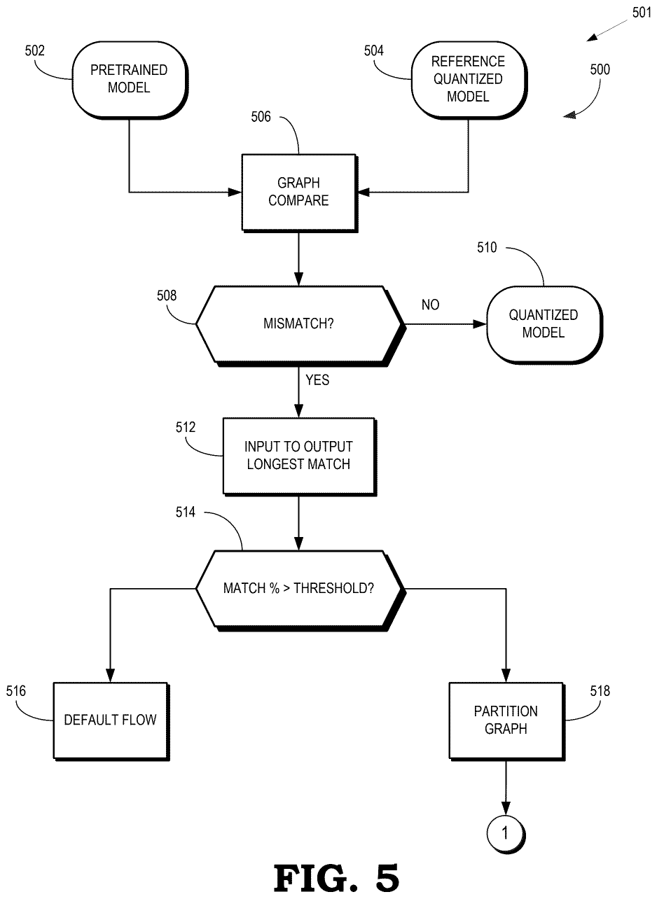

FIG. 5 illustrates the first portion 500 of a method 501 for selectively reusing previously determined quantization parameters for an ML model and re-quantizing remaining quantization parameters for the ML model, according to some embodiments. The method 501 is implemented by a processing system or a processing unit such as some embodiments of the parallel processor 118 shown in FIG. 1. To implement the method 501, the processing unit accesses information representing a pre-trained ML model 502, which can be referred to as “the current ML model 502,” and information representing a reference quantized model 504, which can be referred to as “the previously quantized ML model” because the reference quantized model 504 and represent a quantized version of a previous version of the current ML model 502.

The processing unit implements a predetermined quantization technique or algorithm to quantize parameters of ML models. As discussed herein, the quantization technique or algorithm can change following quantization of a previous version of the ML model, in which case re-quantizing the entire ML model could be preferable. Consequently, the quantization technique that the processing unit uses to re-quantize the current ML model 502 can differ from the quantization technique that was used to quantize a previous version of the ML model to generate the reference quantized model 504. Some embodiments of the processing unit therefore access metadata associated with the quantization technique prior to initiating the first portion 500 of the method 501. The metadata can indicate parameters used during quantization such as the calibration method, quantization type, whether fast finetune is used, and other related settings.

The processing unit can compare the settings for the current quantization technique to the settings or the quantization technique that was used to generate the reference quantized model 504. In response to determining that the settings are the same, a first portion 500 of the method 501 proceeds to the block 506. In response to determining that there are minor changes or differences between the two sets of settings, the first portion 500 of the method 501 proceeds to block 506 after providing a warning that the changes or differences in the settings will be ignored. In some embodiments, the processing unit can provide an option for a user to override this decision and force the processing unit to perform re-quantization of the entire ML model 502. Examples of minor changes include changes to the calibration method, the version of operators, and the like. In response to determining that there are major changes or differences between the two sets of settings, the method 501 ends, and the processing unit reverts to performing re-quantization of the entire ML model 502. Examples of major changes include data type changes, quantization strategy changes such as changing to a weights-only quantization, quantization scheme changes such as changing from per-tensor to per-channel quantization, symmetric changes, changes to the quantization algorithm or parameters of the quantization algorithm, and the like.

At block 506, the processing unit compares a first graph that represents the current ML model 502 and a second graph that represents the reference quantized model 504. As discussed herein with regard to FIG. 2 and FIG. 3, the processing unit bypasses or ignores quantization or dequantization layers or nodes in the reference quantize model 504 when performing the comparison between the first graph and the second graph. In some embodiments, the processing unit compares the first graph and the second graph layer-by-layer beginning at a first layer such as an input layer of the ML model 502 and the previously quantized ML model 504.

At decision block 508, a processing unit determines whether there is a mismatch between any layer or node in the ML model 502 and the previously quantized ML model 504. For example, there is no mismatch between the ML model 200 and the quantized ML model 202 shown in FIG. 2. However, there is a mismatch between the ML model 300 and the quantized ML model 302 shown in FIG. 3. If there is no mismatch detected at decision block 508, method 501 flows to the block 510 and the reference quantized model 504 is reused to represent a quantized version of the ML model 502, in which case no re-quantization is necessary. Some embodiments, the reference quantized model 504 is sent to the next pass in the overall quantization process to perform optimizations and the like. If the processing unit detects a mismatch at decision block 508, the method 501 flows to the block 512.

At block 512, the processing unit determines how much of the ML model 502 and the previously quantized ML model 504 match. In the illustrated embodiment, the processing unit determines a percentage of the nodes or layers in the ML model 502 and the previously quantized ML model 504 that match, beginning from a first layer (such as the input layer) and proceeding layer-by-layer until a mismatch is detected.

At decision block 514, a processing unit determines whether the percentage match between the ML model 502 and the previously quantized ML model 504 is greater than a threshold value. For example, the processing unit can determine whether the percentage match is greater or less than 40%. If the percentage match is less than the threshold, which indicates that a relatively large percentage or fraction of the ML model 502 should be re-quantized and a relatively small percentage or fraction of the previously quantized ML model 504 can be reused, the method 501 flows to the block 516 and the processing unit reverts to the default flow so that the entire ML model 502 is re-quantized. If the percentage match is greater than the threshold, which indicates that a relatively small percentage or fraction of the ML model 502 should be re-quantized and a relatively large percentage or fraction of the previously quantized ML model 504 and the reused, the method 501 flows to the block 518.

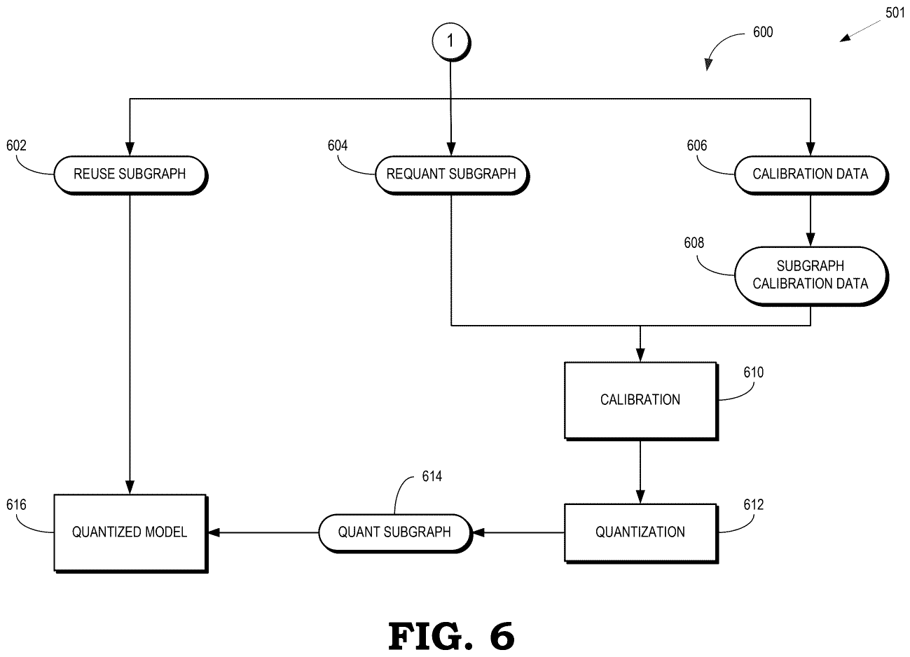

At block 518, a processing unit partitions the graph that represents the ML model 502. Examples of graphs of ML models are the graph of the ML model 200 shown in FIG. 2 and the graph of the ML model 300 shown in FIG. 3. Partitioning the graph creates two subgraphs: a first subgraph that represents nodes or layers of the ML model 502 that can be reused (i.e., the corresponding nodes or layers of the previously quantized ML model 504 are used to represent the updated version of the quantized ML model) and a second subgraph that represents nodes or layers of the ML model 502 that are to be re-quantized to generate the updated version of the quantized ML model. The method 501 then flows to the node 1, which connects the first portion 500 to a second portion 600 that is shown in FIG. 6.

FIG. 6 illustrates the second portion 600 of the method 501 for selectively reusing previously determined quantization parameters for an ML model and re-quantizing remaining quantization parameters for the ML model, according to some embodiments. The second portion 600 is implemented by a processing system or a processing unit such as some embodiments of the parallel processor 118 shown in FIG. 1. In the illustrated embodiment, a second portion 600 of the method 501 receives (at the node 1) information representing the reuse subgraph 602 (e.g., the first subgraph described in FIG. 5) and the re-quantize subgraph 604 (e.g., the second subgraph described in FIG. 5). The reuse subgraph 602 is used to identify a portion of the previously quantized ML model 504 that can be reused to form the updated version of the quantized ML model. The second portion 600 of the method 501 also receives or accesses calibration data 606 associated with the ML model 502. A subset 608 of the calibration data 606 corresponding to the re-quantize subgraph 604 is extracted or accessed from the calibration data 606.

At block 610, the processing unit performs a calibration of the re-quantize subgraph 604 based on the subset 608 of the calibration data 606.

At block 612, the processing unit quantizes the re-quantize subgraph 604 using the calibrated information provided by the block 610. In some embodiments, the processing unit taps the outputs from the reuse subgraph 602 and uses these to quantize the re-quantize subgraph 604 using a default quantization technique or algorithm. The resulting quantize subgraph 614 represents quantized parameters (e.g., weights and activation functions) for the nodes or layers in the re-quantize subgraph 604. The parameters in the quantized subgraph 614 are used to replace parameters in the corresponding portion of the previously quantized ML model 504.

At block 616, the processing unit accesses the portion of the previously quantized ML model 504 corresponding to the reuse subgraph 602. The processing unit also accesses the quantize subgraph 614 corresponding to the re-quantize subgraph 604. The processing unit then combines or merges the quantized subgraphs to form the updated quantized ML model that represents a quantized version of the ML model 502.

Selectively re-quantizing portions of an ML model has several advantages over the conventional practice of re-quantizing the entire ML model. In some cases, a runtime improvement of a factor of 10 or more is achieved by reusing portions of previously quantized ML models instead of re-quantizing these portions. If a subgraph that extends from input to the longest comparison point the graph can be reused, the processing system only needs to operate on the remaining subgraph, which is significantly faster relative to the conventional re-quantization technique. Furthermore, additional incremental optimizations can be enabled if there are fewer modifications to the model, e.g., because only a subset of the nodes or layers are being re-quantized. In addition to long runtimes, large ML models place correspondingly large commands on the available memory resources. Some embodiments of the techniques disclosed herein reduce consumption of memory resources by factors corresponding to the reuse percentage.

In some embodiments, certain aspects of the techniques described above are implemented by one or more processors of a processing system executing software. The software includes one or more sets of executable instructions stored or otherwise tangibly embodied on a non-transitory computer readable storage medium. The software can include instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
based on a comparison between a first graph that represents a version of a machine learning (ML) model and a second graph that represents a previously quantized ML model generated by quantizing a previous version of the ML model, selectively reusing a first subset of quantization parameters from the previously quantized ML model and re-quantizing a second portion of the version of the ML model to form a second subset of the quantization parameters, the first subset generated from quantization of a first portion of the previous version of the ML model; and
combining the first subset and the second subset to form an updated quantized ML model.

2. The method of claim 1, further comprising:
providing a feature map to the updated quantized ML model; and
generating, based on the updated quantized ML model, a value indicating at least one of an identity of a feature in the feature map, a classification of a feature in the feature map, or a value that is predicted based upon the feature map.

3. The method of claim 1, wherein the comparison is performed layer-by-layer beginning at a first layer the version of the ML model and the previously quantized ML model.

4. The method of claim 1, wherein selectively reusing the first subset of quantization parameters and re-quantizing the second portion of the version of the ML model comprises:
forming the updated quantized ML model in response to detecting a mismatch between a first topology of the first graph and a second topology of the second graph.

5. The method of claim 4, wherein the second topology bypasses quantization or dequantization layers in the second graph.

6. The method of claim 4, wherein selectively reusing the first subset of quantization parameters and re-quantizing the second portion of the version of the ML model comprises:
partitioning the first graph into a first subgraph that comprises a matching portion of the first and second graphs and a second subgraph that comprises a mismatched portion of the first and second graphs; and
reusing the first subset of quantization parameters corresponding to the first subgraph and re-quantizing the second portion corresponding to the second subgraph.

7. The method of claim 4, wherein the comparison comprises a detection of a percentage of match between the first topology and the second topology, and wherein selectively reusing the first subset of quantization parameters and re-quantizing the second portion of the version of the ML model comprises reusing the first subset of quantization parameters when the percentage is greater than a threshold.

8. The method of claim 4, wherein the comparison comprises a detection of a percentage of match between the first topology and the second topology, and wherein selectively reusing the first subset of quantization parameters and re-quantizing the second portion of the version of the ML model comprises:
in response to the percentage being less than a threshold, re-quantizing the version of the ML model.

9. The method of claim 1, wherein selectively reusing the first subset of quantization parameters and re-quantizing the second portion of the version of the ML model comprises:
forming the updated quantized ML model based on detecting a change in one or more characteristics of a quantization technique used to quantize the previously quantized ML model and a quantization technique to be used to quantize the version of the ML model.

10. An apparatus comprising:
at least one processing unit comprising at least one processor core configured to:
based on a comparison between a first graph that represents a version of a machine learning (ML) model and a second graph that represents a previously quantized ML model generated by quantizing a previous version of the ML model, selectively reuse a first subset of quantization parameters from the previously quantized ML model and re-quantize a second portion of the version of the ML model to form a second subset of the quantization parameters, the first subset generated from quantization of a first portion of the previous version of the ML model; and
combine the first subset and the second subset to form an updated quantized ML model.

11. The apparatus of claim 10, wherein the comparison is performed layer-by-layer beginning at a first layer the version of the ML model and the previously quantized ML model.

12. The apparatus of claim 10, wherein the at least one processing unit is configured to:
form the updated quantized ML model in response to detecting a mismatch between a first topology of the first graph and a second topology of the second graph.

13. The apparatus of claim 12, wherein the second topology bypasses quantization or dequantization layers in the second graph.

14. The apparatus of claim 12, wherein the at least one processing unit is configured to:
partition the first graph into a first subgraph that comprises a matching portion of the first and second graphs and a second subgraph that comprises a mismatched portion of the first and second graphs; and
reuse the first subset of quantization parameters corresponding to the first subgraph and re-quantizing the second portion corresponding to the second subgraph.

15. The apparatus of claim 12, wherein the comparison comprises a detection of a percentage of match between the first topology and the second topology, and wherein the at least one processing unit is configured to selectively reuse the first subset of quantization parameters, and wherein the at least one processing unit is configured to reuse the first subset of quantization parameters in response to the percentage being greater than a threshold.

16. The apparatus of claim 12, wherein the comparison comprises a detection of a percentage of match between the first topology and the second topology, and wherein the at least one processing unit is configured to:
re-quantize the version of the ML model in response to the percentage being less than a threshold.

17. The apparatus of claim 10, wherein the at least one processor is configured to:
form the updated quantized ML model based on detecting a change in one or more characteristics of a quantization technique used to quantize the previously quantized ML model and a quantization technique to be used to quantize the version of the ML model.

18. A method comprising:
selectively re-quantizing a first portion of a first machine learning (ML) model and reusing a second portion of a second ML model based on a comparison of the first ML model and the second ML model, the first ML model having a floating-point representation and the second ML model being generated by quantizing a previous version of the first ML model to form a fixed point representation;
combining the first portion and the second portion to form an updated second ML model; and
providing the updated second ML model to a device that is configured to perform inference using the updated second ML model.

19. The method of claim 18, further comprising:
comparing a first topology of the first ML model to a second topology of the second ML model.

20. The method of claim 18, wherein further comprising:
providing a feature map to the updated second ML model; and
performing inference on the updated second ML model to generate a value indicating at least one of an identity of a feature in the feature map, a classification of a feature in the feature map, or a value that is predicted based upon the feature map.
